(19) United States
(12) Patent Application Publication
(10) Pub. No.: US 2018/0058334 A1
(43) Pub. Date: Mar. 1, 2018

(54) SYSTEM AND METHOD TO VARY EXHAUST BACKPRESSURE ON GAS TURBINE

(71) Applicant: General Electric Company, Schenectady, NY (US)

(72) Inventors: George Vargese MATHAI, Atlanta, GA (US); Alston Ilford Scipio, Atlanta, GA (US); Sanji Ekanayake, Atlanta, GA (US); Joseph Philip Klosinki, Atlanta, GA (US); Larry William Swanson, Irvine, CA (US)

(21) Appl. No.: 15/252,080

(22) Filed: Aug. 30, 2016

(51) Int. Cl. F02C 9/20; F01K 23/10

(52) U.S. Cl. CPC F02C 9/20; F01K 23/10

(57) ABSTRACT

A method to adjust the back pressure applied to an exhaust of a gas turbine, the method including: exhausting hot combustion gas from the gas turbine; passing the hot combustion gas through a heat recovery steam generator; actuating an exhaust gas damper in the stream of the hot combustion gases, wherein actuation moves the exhaust gas damper to a restricted position, and while in the restricted position, the exhaust damper creates a backpressure applied to the exhaust gas, wherein the backpressure reduces an exhaust gas velocity at an exhaust of the gas turbine.

### BACKGROUND OF THE INVENTION

The invention relates generally to controlling industrial gas turbines and specifically to the controlling the backpressure applied to the exhaust of the turbine.

Gas turbines produce power by extracting energy from combustion gases passing through the turbine section of the gas turbine. The amount of extracted energy depends on the pressure difference between the inlet to the turbine and its outlet. The lower the pressure at the turbine outlet the greater the amount of power extracted by the turbine. The pressure at the outlet of the turbine is directly related to the backpressure applied to the outlet of the turbine. Thus, lowering the backpressure applied to a gas turbine increases the power generation efficiency of the gas turbine.

It is conventional wisdom to reduce the backpressure as much as practical to increase power production of the gas turbine. Conventional techniques are well known to reduce exhaust backpressure to a static pressure as low as atmospheric pressure. Similarly, the heat recovery steam generator (HRSG) connected to the exhaust duct is designed to minimize back pressure applied to the exhaust gases leaving the gas turbine.

### BRIEF DESCRIPTION OF THE INVENTION

The inventors conceived of and disclosed herein an invention which increases backpressure during certain operating conditions of a gas turbine at which the turbine would otherwise suffer turbine blade flutter or other mechanical vibrations in the turbine. The flutter or other vibrations are caused by excessive velocity of the exhaust gas leaving the gas turbine and entering the exhaust duct, which may be as low as an atmospheric static pressure. Increasing the backpressure reduces the velocity of the gases leaving the turbine. Because the gas velocity is reduced, there is less flutter and other mechanical vibrations due to the exhaust of gases from the gas turbine.

Gas turbines typically have operational limits that restrict the conditions under which the gas turbine may be safely and properly operated. A maximum exhaust gas level, which may be designated as a maximum axial gas velocity, is an operational limit in some industrial gas turbines. The maximum exhaust gas velocity is an operating condition that prevents the operation of a gas turbine at conditions where the actual exhaust gas velocity would exceed the maximum exhaust gas velocity.

The current invention applies a backpressure sufficient to reduce the actual exhaust velocity such that the gas turbine does not exceed the maximum exhaust gas velocity. Reducing the exhaust gas velocity allows the gas turbine to continue operating within its operational limit and avoid excessive flutter and other mechanical vibrations in the turbine which might result from excessive gas velocity through the gas turbine.

Further, the increased backpressure may also applied to the heat recovery steam generator (HRSG) to reduce the velocity of the hot combustion gas flowing through the HRSG. Lowering the exhaust gas velocity allows the HRSG to extract additional heat energy from the combustion gases. The extra heat energy is applied to generate more steam to drive a steam turbine. The steam turbine may be operated with greater steam which results in a greater power output from the steam turbine.

A method to adjust the back pressure applied to an exhaust of a gas turbine, the method including: exhausting hot combustion gas from the gas turbine; passing the hot combustion gas through a heat recovery steam generator; actuating an exhaust gas damper in the stream of the hot combustion gases, wherein actuation moves the exhaust gas damper to a restricted position, and while in the restricted position, the exhaust damper creates a backpressure applied to the exhaust gas, wherein the backpressure reduces an exhaust gas velocity at an exhaust of the gas turbine.

A method to adjust the back pressure applied to an exhaust of a gas turbine, the method comprising: operating the gas turbine and exhausting hot combustion gases from the gas turbine into an exhaust duct; passing the hot combustion gases through a heat recovery steam generator connected to the exhaust duct, wherein the hot combustion gases continue to pass through the exhaust duct downstream of the heat recovery steam generator; actuating an exhaust gas damper mounted to the exhaust duct, wherein the exhaust gas damper is moved to an open position during a first operational condition of the gas turbine and to a restricted position during a second operational condition of the gas turbine; while in the open position, the exhaust gas damper applies negligible or minimal backpressure to the hot combustion gas passing through the damper, and while in the restricted position, the exhaust damper creates a backpressure applied to the hot combustion gas, wherein the backpressure reduces a hot combustion gas velocity at the exhaust to the gas turbine.

A gas turbine and steam turbine system comprising: a gas turbine and an exhaust duct connected to a hot combustion gas outlet of the gas turbine; a heat recovery steam generator connected to the exhaust duct and configured to transfer heat energy from the hot combustion gas from the gas turbine to steam; an exhaust gas and stack assembly downstream of the heat recovery steam generator; a damper in the exhaust gas and stack assembly, wherein the damper is configured to be actuated to restrict gas turbine combustion gases flowing and thereby apply a back pressure to the gas turbine and reduce a velocity of the combustion gases leaving the gas turbine, and a steam turbine receiving the steam from the heat recovery steam generator.

### BRIEF DESCRIPTION OF THE DRAWINGS

FIG. 1 is a schematic view of a gas turbine, HRSG and steam turbine power production system;

FIG. 2 is flow chart of steps to control an exhaust damper to increase the back pressure applied to a gas turbine.

### DETAILED DESCRIPTION OF THE INVENTION

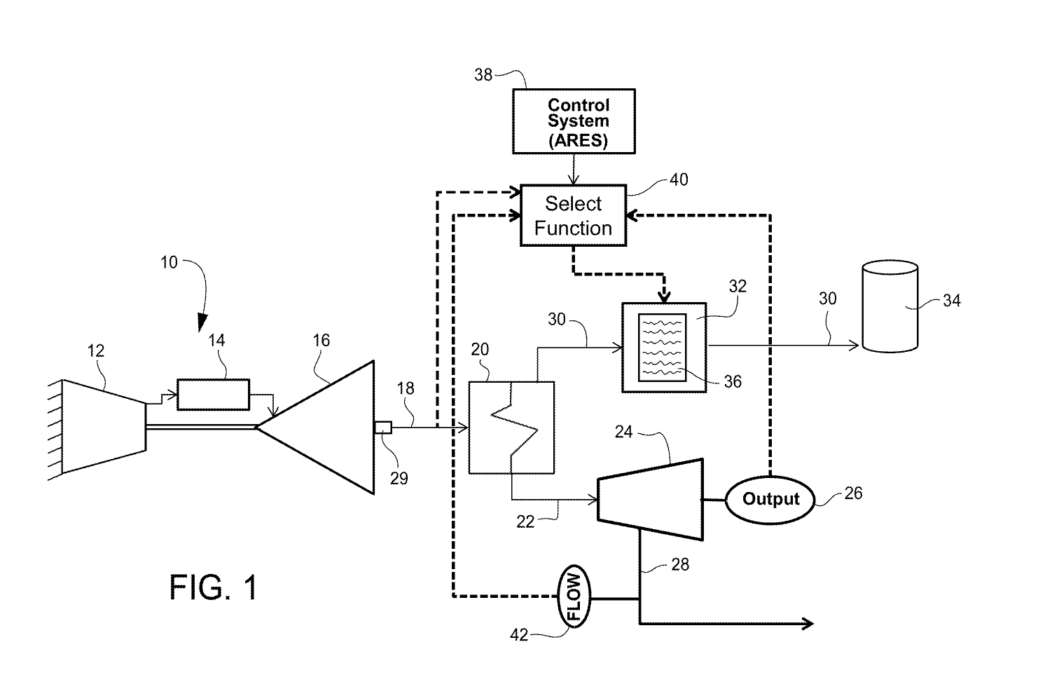

FIG. 1 shows schematically a gas turbine 10 which includes a compressor 12, a combustor 14 and a turbine 16. Exhaust from the turbine flows through an exhaust duct 18 to a heat recovery steam generator (HRSG) 20. A heat exchanger in the HRSG uses heat energy from the turbine exhaust gas to heat steam or water that flows through a duct 22 to a steam turbine 24. Power generated by the steam turbine is produced as output power 26. Steam 28 exhausted from the steam turbine may be applied for heating and other uses. Power is also generated by the gas turbine. The combined system of the gas turbine and steam turbine may form a combined-cycle power plant or a co-generation power plant.

The exhaust gas flow through the exhaust gas duct 18 may be monitored by a sensor 29 that monitors, for example, the axial velocity of the exhaust gas at the outlet of the last stage row of turbine buckets in the turbine 16. The sensor may provide data indicating a velocity, such as in a Mach number, of the exhaust gas flow. Alternatively, or in addition, the sensor 29 may provide data regarding the static or dynamic pressure of the exhaust gas at the outlet of the gas turbine.

The exhaust gas from the gas turbine 10 flows through the HRSG 20 and passes, via an exhaust duct 30, through a damper 32 and then to an exhaust stack 34. The exhaust damper may include a row of louvers 36 in the exhaust duct 30 downstream of the HRSG. Other types of exhaust dampers may also be used. Other types include, for example, adjustable constrictions in the exhaust duct, a flap or spoiler that pivots in the exhaust duct, pivoting vanes in the exhaust gas duct, a guillotine damper and a butterfly valve. The exhaust damper is adjusted to provide various amounts of flow construction and thus to apply various levels of backpressure to the exhaust gas flowing from the HRSG to the exhaust stack. While in an entirely open position, the exhaust damper may apply no, negligible, or a minimal amount of flow restriction and backpressure on the exhaust stream.

The exhaust damper may be adjusted to increase the amount of flow restriction and hence backpressure applied to the exhaust gas. The amount of backpressure applied is selectable. The exhaust damper need not be configured to fully shut off exhaust gas flow through the exhaust duct 30. Rather, the exhaust damper may be configured to have a maximum restriction of airflow of only five to thirty percent of the airflow capacity of the exhaust duct.

The exhaust damper may be downstream of the HRSG 20, such as in an exhaust duct 30 between the HRSG and stack 34. Alternatively, the exhaust damper may be in the stack, within the HRSG, or in the exhaust duct upstream of the HRSG and downstream of the gas turbine.

A control system 38 may determine and actuate the exhaust damper, such as to switch the exhaust damper from a fully open position or to a certain flow restriction value. The control system may be a computer controller, such as one specially configured to monitor and control the gas turbine 10. The control system may include a non-transitory memory which includes instructions, e.g., a computer program, that when executed by a processor cause the control system to perform a select function operation 40 to control and actuate the exhaust damper 32.

The control system may monitor sensors that provide electronic information regarding the flow 42 of steam 28 exhausted from the steam turbine 24. The flow 42 may be, for example, in terms of rate of steam flow in terms of mass or volume, and temperature of steam flow. The control system may also monitor the power output 26 from the steam turbine.

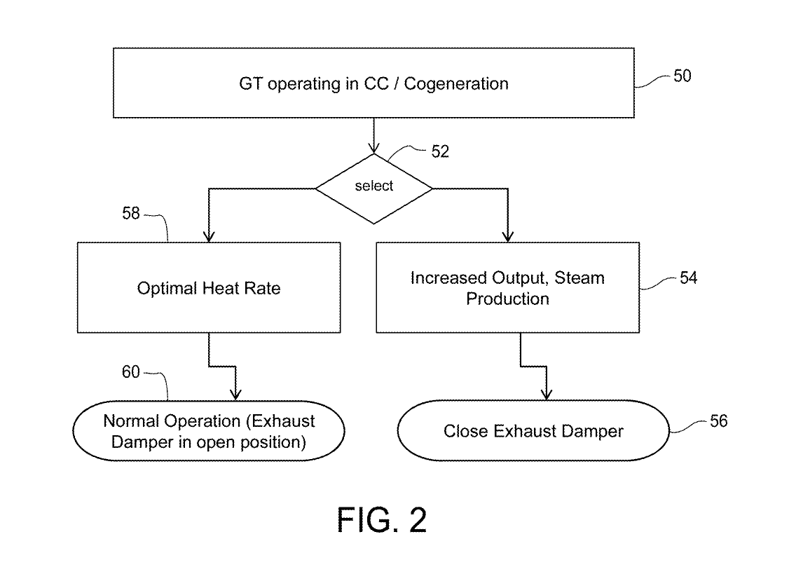

FIG. 2 is a flow chart showing an exemplary select function operation by the control system. In step 50, the gas turbine (GT) is operated in a combined cycle or cogeneration system with a steam turbine. The control system 38 (FIG. 1) operates the gas turbine. Controlling the gas turbine includes monitoring the steam turbine, such as monitoring the steam exhaust flow 42 and power output 26 of the steam turbine.

The control system performs a selection process 52 to determine whether to adjust the damper and, if so, a desired adjustment to be made to the damper. In a first example, the selection is based on the axial velocity of the turbine exhaust gas flow. If the axial velocity exceeds a specified velocity, such as a certain Mach number, the selection process directs the control system to perform step 54 to increase the power output and steam throughput of the steam turbine and step 56 to actuate the exhaust damper to increase backpressure applied to the gas turbine exhaust flow.

In step 54, the control system monitors the power output of the steam turbine and the steam exhausted by the steam turbine. The power output and the amount of exhaust steam may be increased as compared to the steam turbine output and steam flow if the steam turbine and gas turbine were operated at optimal heat rate settings. The steam turbine power output and steam flow through the steam turbine are increased in view of the slower flow of hot gases from the gas turbine through the HRSG. This slower flow allows the HRSG to extract a greater amount of heat energy from the hot gases as compared to the hot gases flowing at a higher velocity. Because a greater amount of energy is extracted by the HRSG the amount of steam generated by the HRSG is increased and the steam turbine may be operated at an increased power output.

In step 56, the control system actuates the damper to increase the backpressure in the exhaust duct 30 downstream of the HRSG. The increase of backpressure in exhaust duct 30 causes an increase in back pressure in the exhaust duct 18 at the outlet of the gas turbine. This increase in backpressure at the outlet of the gas turbine reduces the axial velocity of the exhaust gas leaving the gas turbine. The reduction in axial velocity may be selected to be sufficient to reduce the axial velocity below operation limits on the axial exhaust velocity of the gas turbine. By reducing the axial exhaust velocity of the gas turbine exhaust to below an operational limit, the gas turbine may be safely operated. If the axial exhaust velocity had not been reduced, the gas turbine may not have been permitted to operate due to the excessive velocity of the exhaust gas.

Step 56 may optionally include controlling the degree to which the damper restricts the exhaust gas to achieve a desired level of backpressure or a desired reduction in the axial exhaust gas velocity at the outlet of the gas turbine. A pressure sensor 29 or axial gas velocity flow meter 29 at the outlet of the gas turbine provides data regarding the axial gas velocity or pressure at the outlet of the gas turbine. This data is provided to the control system which uses the data to determine a degree to which the exhaust gas damper is closed to provide a desired combustion gas pressure or axial gas flow velocity. The control system may continue to monitor the sensor or flow meter 29 to confirm that the desired pressure or gas velocity is achieved by the actuation of the exhaust gas damper.

If the selection process, step 52, determines that the axial velocity of the gas turbine exhaust is below the specified velocity, the selection process invokes step 58 which causes the gas turbine to be operated at its optimal heat rate and step 60 which actuates the damper to a fully open position.

The exhaust damper and the operation for actuating the damper may be applied to avoid operating the gas turbine at certain ambient and load conditions that would exceed limits of the gas turbine. For example, excessive velocity of the exhaust gas passing through the last row of turbine buckets may cause the buckets to flutter or otherwise vibrate. Reducing the axial velocity of the exhaust gas reduces the risk of excessive fluttering in the turbine buckets.

If the backpressure were not increased to reduce the axial exhaust velocity, the operation of the gas turbine would have to be adjusted, e.g., derated, to reduce the exhaust velocity. The adjustment would reduce the power output of the gas turbine and the amount of exhaust gas from the gas turbine.

By having a damper to increase backpressure and reduce axial velocity, the gas turbine may continue to be operated at a high power output, although slightly reduced power than if no axial velocity restriction, and not derated. Further, the amount of steam generated in the HRSG for the steam turbine is increased due to the slower exhaust gas. The increase in steam is used to increase the power output of the steam turbine.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method to adjust the back pressure applied to an exhaust of a gas turbine, the method comprising:
exhausting hot combustion gas from the gas turbine;
passing the hot combustion gas through a heat recovery steam generator;
actuating an exhaust gas damper in the stream of the hot combustion gases, wherein actuation moves the exhaust gas damper to a restricted position, and
while in the restricted position, the exhaust damper creates a backpressure applied to the exhaust gas, wherein the backpressure reduces an exhaust gas velocity at an exhaust of the gas turbine.

2. The method of claim 1 wherein the exhaust gas damper is downstream in the hot combustion gas stream of the heat recovery steam generator or within the heat recovery steam generator.

3. The method of claim 1 wherein the method further includes extracting heat energy from the hot exhaust gases by the heat recovery steam generator and applying the extracted energy to heat steam;
applying the heated steam to drive a steam turbine; and
increasing a power output of the steam turbine due to the exhaust gas damper being moved to the restricted position.

4. The method of claim 1 further comprising selecting an open position and the restricted position of the exhaust gas damper based on whether a velocity of the hot combustion gases from the gas turbine exceeds a certain limit on velocity of the hot combustion gases.

5. The method of claim 1 further comprising selecting an open position and the restricted position based of the exhaust gas damper based on whether an axial velocity of the hot combustion gases at the gas turbine exceeds a certain limit on axial velocity of the hot combustion gases.

6. The method of claim 1 wherein the actuation of the exhaust gas damper includes restricting the hot combustion gas sufficiently to achieve a desired exhaust gas velocity or a desired pressure at a hot gas outlet of the gas turbine.

7. The method of claim 6 further comprising monitoring at least one of the exhaust gas velocity and pressure at the hot gas outlet during the actuation of the exhaust gas damper to determine whether the desired exhaust gas velocity or the desired pressure is achieved.

8. A method to adjust the back pressure applied to an exhaust of a gas turbine, the method comprising:
operating the gas turbine and exhausting hot combustion gases from the gas turbine into an exhaust duct;
passing the hot combustion gases through a heat recovery steam generator connected to the exhaust duct, wherein the hot combustion gases continue to pass through the exhaust duct downstream of the heat recovery steam generator;
actuating an exhaust gas damper mounted to the exhaust duct or the heat recovery steam generator, wherein the exhaust gas damper is moved to an open position during a first operational condition of the gas turbine and to a restricted position during a second operational condition of the gas turbine;
while in the open position, the exhaust gas damper applies negligible or minimal backpressure to the hot combustion gas passing through the damper, and
while in the restricted position, the exhaust damper creates a backpressure applied to the hot combustion gas, wherein the backpressure reduces a hot combustion gas velocity at an exhaust to the gas turbine.

9. The method of claim 8 wherein the exhaust gas damper is downstream in the hot combustion gas stream of the heat recovery steam generator.

10. The method of claim 8 wherein the method further includes extracting heat energy from the hot exhaust gases by the heat recovery steam generator and applying the extracted energy to heat steam;
applying the heated steam to drive a steam turbine; and
increasing a power output of the steam turbine due to the exhaust gas damper being moved to the restricted position.

11. The method of claim 8 further comprising selecting an open position and the restricted position of the exhaust gas damper based on whether a velocity of the hot combustion gases from the gas turbine exceeds a certain limit on velocity of the hot combustion gases.

12. The method of claim 8 further comprising selecting an open position and the restricted position based of the exhaust gas damper based on whether an axial velocity of the hot combustion gases at the gas turbine exceeds a certain limit on axial velocity of the hot combustion gases.

13. The method of claim 8 wherein the actuation of the exhaust gas damper includes restricting the hot combustion gas sufficiently to achieve a desired exhaust gas velocity or a desired pressure at a hot gas outlet of the gas turbine.

14. The method of claim 13 further comprising monitoring at least one of the exhaust gas velocity and pressure at the hot gas outlet during the actuation of the exhaust gas damper to determine whether the desired exhaust gas velocity or the desired pressure is achieved.

15. A gas turbine and steam turbine system comprising:
a gas turbine and an exhaust duct connected to a hot combustion gas outlet of the gas turbine;
a heat recovery steam generator connected to the exhaust duct and configured to transfer heat energy from the hot combustion gas from the gas turbine to steam;
an exhaust gas and stack assembly downstream of the heat recovery steam generator;
a damper in the heat recovery steam generator or the exhaust gas and stack assembly, wherein the damper is configured to be actuated to restrict gas turbine combustion gases flowing and thereby apply a back pressure to the gas turbine and reduce a velocity of the combustion gases leaving the gas turbine, and
a steam turbine receiving the steam from the heat recovery steam generator.

16. The gas turbine and steam turbine system as in claim 15 further comprising a control system configured to actuate the damper to restrict the gas turbine combustion gases in response to a certain operational condition of the gas turbine.

17. The gas turbine and steam turbine system of claim 16 wherein the certain operational condition is a velocity of the combustion gas at the outlet of the gas turbine exceeding a velocity maximum for the gas turbine.

18. The gas turbine of claim 15 wherein the damper has an open position at which a nominal or minimal restriction is applied by the damper to the hot combustion gas and a restricted position at which the damper applies a restriction to the hot combustion gas.

19. The gas turbine and steam turbine system of claim 18 further comprising a control system configured to select whether to actuate the damper to the open position or to the restricted position based on whether a gas velocity of the hot combustion gases at the outlet of the gas turbine exceeds a maximum velocity setting.

20. The gas turbine and steam turbine system of claim 15 wherein the restriction of the hot combustion gas creates less than a 30 percent increase in the backpressure.
